(19) United States
(12) Patent Application Publication
(10) Pub. No.: US 2026/0229118 A1
(43) Pub. Date: Aug. 6, 2026

(54) INFORMATION PROCESSING DEVICE FOR VEHICLE

(71) Applicant: TOYOTA JIDOSHA KABUSHIKI KAISHA, Toyota-shi (JP)

(72) Inventor: Kosuke OHASHI, Kiyosu-shi (JP)

(73) Assignee: TOYOTA JIDOSHA KABUSHIKI KAISHA, Toyota-shi (JP)

(21) Appl. No.: 19/363,982

(22) Filed: Oct. 21, 2025

(30) Foreign Application Priority Data
Feb. 3, 2025 (JP) 2025-016119

(51) Int. Cl. G08G 1/123; G01S 19/42; G08G 1/052; G08G 1/056

(52) U.S. Cl. CPC G08G 1/123; G01S 19/42; G08G 1/052; G08G 1/056

(57) ABSTRACT

An information processing device includes a position information acquisition device that acquires information indicating a position of a vehicle, an information transmission device that periodically transmits the information indicating the position of the vehicle acquired by the position information acquisition device to a server, and a storage device. The information processing device sets a transmission interval for transmitting the information indicating the position of the vehicle to the server such that the transmission interval becomes shorter as a vehicle speed of the vehicle decreases. The information processing device is configured to determine whether a recording trigger condition is satisfied based on a change in a traveling direction of the vehicle, and when the recording trigger condition is determined to be satisfied, to store information indicating a position of the vehicle at a time when the recording trigger condition is satisfied in a storage device.

### CROSS-REFERENCE TO RELATED APPLICATION

This application claims priority to Japanese Patent Application No. 2025-016119 filed on February 3, 2025. The disclosure of the above-identified application, including the specification, drawings, and claims, is incorporated by reference herein in its entirety.

### BACKGROUND

### Technical Field

The present disclosure relates to an information processing device for a vehicle.

### Description of Related Art

Japanese Unexamined Patent Application Publication No. 2022-143024 (JP 2022-143024 A) discloses a system including a server and an in-vehicle information communication device. The in-vehicle information communication device transmits information on a current position of a vehicle to the server. The in-vehicle information communication device transmits the position information to the server when a road is congested, such as when a traffic jam occurs, and restrains transmission of the position information when the road is not congested. With such a configuration, the in-vehicle communication device can keep the number of communications low when the road is not congested, and efficiently notify the server of the position of the vehicle when the road is congested, thereby providing information on the congestion status of the road.

### SUMMARY

The position information of the vehicle can be used for grasping the congestion status, as well as for recording a traveling history of the vehicle, a traffic flow survey, or the like. When the communication frequency between the server and the information processing device that is mounted on the vehicle and transmits the position information of the vehicle to the server is too low, the position of the vehicle cannot be accurately identified. On the other hand, when the communication frequency between the information processing device and the server is too high, the load on the information processing device increases.

Hereinafter, means for solving the above problem and effects thereof will be described.

An information processing device for a vehicle for solving the problems described above includes:

a position information acquisition device configured to acquire information indicating a position of the vehicle;

an information transmission device configured to periodically transmit, to a server, the information indicating the position of the vehicle acquired by the position information acquisition device; and

a storage device.

The information processing device for the vehicle is configured to set a transmission interval for transmitting the information indicating the position of the vehicle to the server such that the transmission interval becomes shorter as a vehicle speed of the vehicle decreases. The information processing device for the vehicle is configured to determine whether a recording trigger condition is satisfied based on a change in a traveling direction of the vehicle, and when the recording trigger condition is determined to be satisfied, store, in the storage device, information indicating a position of the vehicle at a time when the recording trigger condition is satisfied.

With the information processing device for the vehicle, it is possible to accurately determine a course change that is independent of a road or a terrain, so that a right or a left turn or a U-turn at an intersection, a branch point, or the like can be accurately recorded.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of an information processing system including an information processing device for a vehicle according to the embodiment;

FIG. 2 is a flowchart showing a flow of a process of transmitting position information of the vehicle by the information processing device for a vehicle according to the embodiment;

FIG. 3 is a flowchart showing a flow of a process using a recording trigger condition by the information processing device for a vehicle according to the embodiment;

FIG. 4A is a diagram for describing whether the recording trigger condition is satisfied in a case where a right turn is made at the intersection, and is a schematic diagram showing the behavior of the vehicle when the vehicle makes a right turn;

FIG. 4B is a diagram for describing whether the recording trigger condition is satisfied in a case where the right turn is made at the intersection, and is a time chart showing the true azimuth of the vehicle with respect to elapsed time;

FIG. 5A is a diagram for describing whether the recording trigger condition is satisfied in a case where the vehicle changes lanes, and is a schematic diagram showing the behavior of the vehicle when the vehicle makes a lane change;

FIG. 5B is a diagram for describing whether the recording trigger condition is satisfied in a case where the vehicle makes a lane change, and is a time chart showing the true azimuth of the vehicle with respect to elapsed time; and

FIG. 6 is a diagram for describing an example of determining a travel route of a vehicle by using the information processing device for a vehicle according to the embodiment.

### DETAILED DESCRIPTION OF EMBODIMENTS

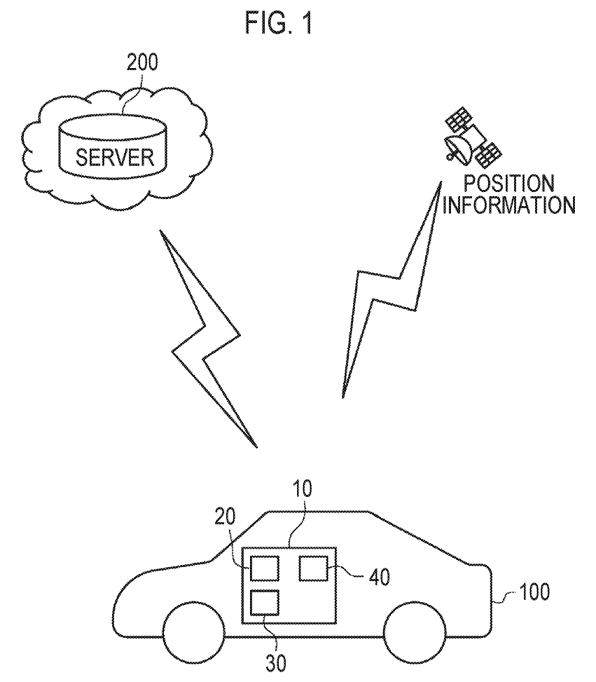

The embodiment of the information processing device 10 for a vehicle will be described below with reference to FIGS. 1 to 6.

### Configuration of Information Processing Device 10

As shown in FIG. 1, the information processing device 10 is mounted on the vehicle 100. The information processing device 10 is connected to be communicable with the server 200. The information processing device 10 transmits information indicating the current position of the vehicle 100 to the server 200. The information processing device 10 constitutes an information processing system of the vehicle together with the server 200. The server 200 manages information on the congestion status of the road or information on the traveling history of the vehicle 100 based on the information indicating the position of the vehicle 100. The information can be used for a traffic flow survey or the like. The server 200 collects and analyzes data on the position information of a large number of vehicles. The server 200 organizes and provides the collected data.

As shown in FIG. 1, the information processing device 10 is configured to include a position information acquisition device 20, an information transmission device 30, and a storage device 40. The position information acquisition device 20 acquires information indicating the current position of the vehicle 100. In the present embodiment, the position information acquisition device 20 acquires information indicating the current position of the vehicle 100 using radio waves from satellites received by a receiver of a satellite positioning system. The information indicating the current position of the vehicle 100 is also referred to as position information.

The information transmission device 30 periodically transmits the position information of the vehicle 100 acquired by the position information acquisition device 20 to the server 200. The transmission interval of the position information is set according to the speed of the vehicle 100. The transmission interval is an interval at which the information transmission device 30 transmits the position information of the vehicle 100 to the server 200. The transmission interval is set to be shorter as the speed of the vehicle 100 decreases. That is, in a case where the transmission interval is short, the frequency at which position information is transmitted to the server 200 is higher than in a case where the transmission interval is long, and more granular position information is transmitted to the server 200.

The storage device 40 is implemented by, for example, a random access memory (RAM), a read only memory (ROM), a hard disk drive (HDD), or the like. The storage device 40 stores information indicating the position of the vehicle 100 or the like.

### Flow of Process of Transmitting Position Information of Vehicle 100 by Information Processing Device 10

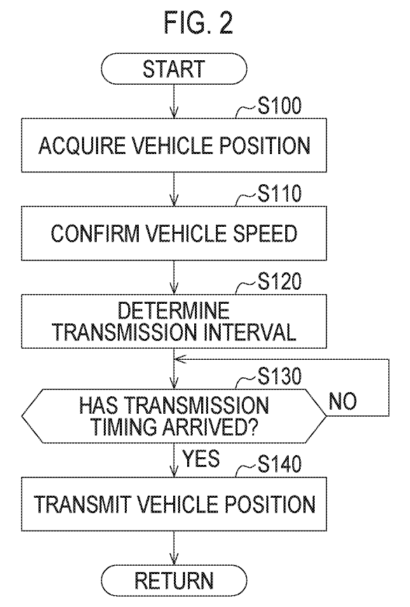

Hereinafter, with reference to FIG. 2, a flow of a process of transmitting the position information of the vehicle 100 by the information processing device 10 will be specifically described. The series of processes shown in FIG. 2 is repeatedly executed by the information processing device 10 while the vehicle 100 is in operation. As shown in FIG. 2, when the series of processes is started, the information processing device 10 first acquires the position information of the vehicle 100 by the position information acquisition device 20 in the process of S100. Then, the information processing device 10 advances the process to S110.

In the process of S110, the information processing device 10 confirms the speed of the vehicle 100. The speed of the vehicle 100 may use a speed that can be obtained by known methods such as a speed detected by a vehicle speed sensor mounted on the vehicle 100, a speed displayed on a dashboard of the vehicle 100. Then, the information processing device 10 advances the process to S120, and in the process of S120, the information processing device 10 determines the transmission interval for transmitting the position information of the vehicle 100 to the server 200 according to the speed of the vehicle 100 acquired in S110. Next, the information processing device 10 advances the process to S130, and in the process of S130, the information processing device 10 determines whether the transmission timing corresponding to the transmission interval determined in S120 has arrived. When the transmission timing corresponding to the transmission interval has arrived (S130: YES), the information processing device 10 advances the process to S140. The information processing device 10, in the process of S140, transmits the position information of the vehicle 100 acquired through the process of S100 to the server 200. On the other hand, when the transmission timing corresponding to the transmission interval has not arrived (S130: NO), the information processing device 10 repeatedly executes the process of S130.

Then, the information processing device 10 returns the series of processes.

### Flow of Process Using Recording Trigger Condition

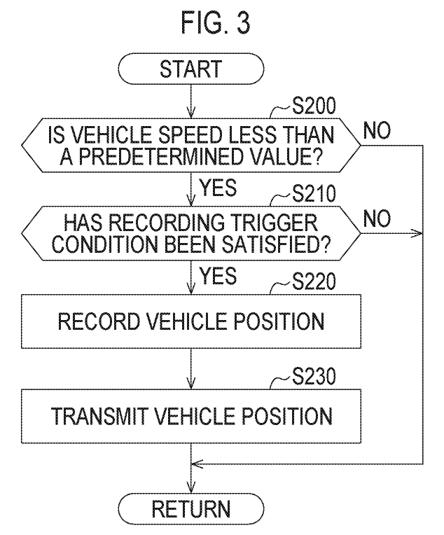

Hereinafter, with reference to FIG. 3, a flow of a process of recording the position of the vehicle 100 using the recording trigger condition by the information processing device 10 will be specifically described. The series of processes is repeatedly executed by the information processing device 10 while the vehicle 100 is in operation. As shown in FIG. 3, when the series of processes is started, the information processing device 10 first determines, in the process of S200, whether the speed of the vehicle 100 is lower than a predetermined value. When the information processing device 10 determines in the process of S200 that the speed of the vehicle 100 is lower than the predetermined value (S200: YES), the information processing device 10 advances the process to S210. On the other hand, when the information processing device 10 determines in the process of S200 that the speed of the vehicle 100 is equal to or higher than the predetermined value (S200: NO), the information processing device 10 returns the process.

When the information processing device 10 advances the process to S210, the information processing device 10 determines in the process of S210 whether the recording trigger condition is satisfied. In the present embodiment, the recording trigger condition is a condition for automatically starting to record the information indicating the position of the vehicle 100 when a specific event or situation occurs. The recording trigger condition is, for example, a logical AND condition of the following two conditions. That is, the information processing device 10 determines that the recording trigger condition is satisfied by the state in which both of the following two conditions are satisfied.

A change exists between the true azimuth immediately before the traveling direction of the vehicle 100 starts to change and the true azimuth at a point in time when the traveling direction of the vehicle 100 stops changing.

∙ The traveling direction has changed by 45 degrees or more during the period from when the traveling direction of the vehicle 100 starts to change to when the traveling direction of the vehicle 100 stops changing.

The true azimuth is an azimuth angle measured with true north as a reference, with clockwise being a positive angle. When the traveling direction is indicated by the true azimuth, the northward traveling is 0 degrees, the eastward traveling is 90 degrees, the southward traveling is 180 degrees, and the westward traveling is 270 degrees.

When the information processing device 10 determines in the process of S210 that the recording trigger condition is satisfied (S210: YES), the information processing device 10 advances the process to S220, and records the position information of the vehicle 100 in the process of S220. Further, the information processing device 10 advances the process to S230, and transmits the position information of the vehicle 100 to the server 200 in the process of S230. Then, the information processing device 10 returns the series of processes.

On the other hand, when the information processing device 10 determines in the process of S210 that the recording trigger condition is not satisfied (S210: NO), the information processing device 10 returns the process.

### Case Where Vehicle 100 Makes Right Turn at Intersection

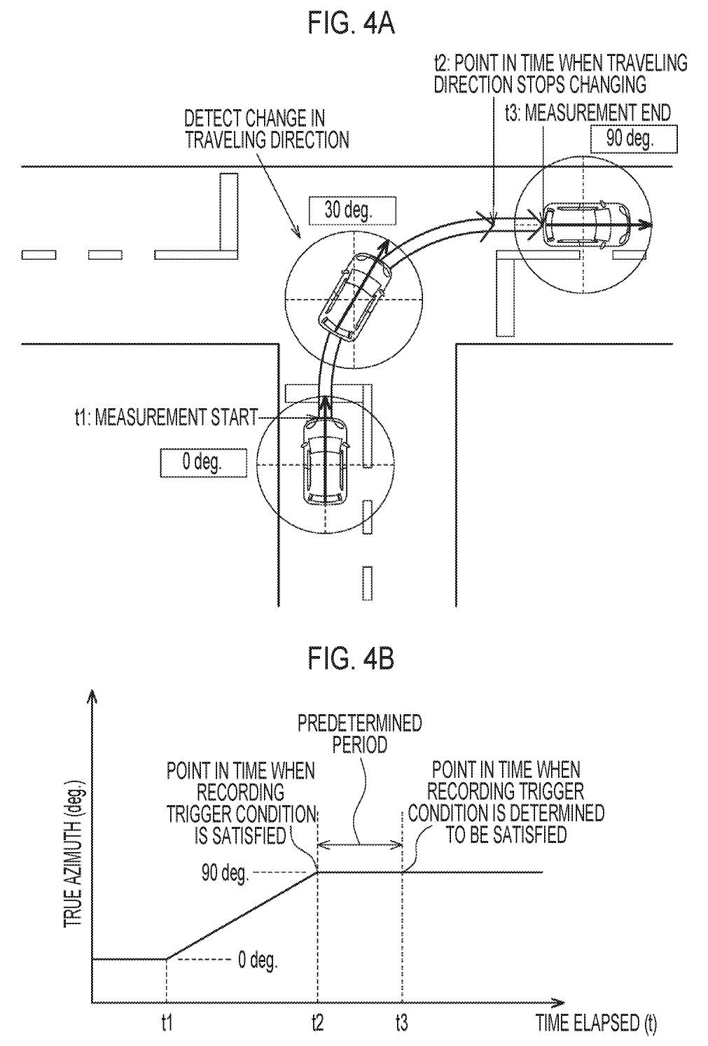

Hereinafter, specific examples of cases where the vehicle 100 makes a right turn at the intersection will be described with reference to FIGS. 4A and 4B. In the present embodiment, the change in the true azimuth of the vehicle 100 is detected by detecting the turning of the vehicle 100. As means for detecting the turning motion of the vehicle 100, a known technique may be used by using various sensors mounted on the vehicle 100. For example, an angular velocity sensor is used to measure the angular velocity in real time when the vehicle turns, and the turning motion of the vehicle is detected based on the measured values. In addition, a detection that the vehicle is traveling on a curve such as a right or left turn is made by using an acceleration sensor to measure a lateral acceleration (lateral G) generated when the vehicle turns in real time. Further, there is also a method of detecting an entry into a curve by measuring an angle at which a driver turns a steering wheel by using a steering angle sensor and predicting a movement at which a vehicle turns from a result of the measurement. In addition, a vehicle turning motion is detected by using a wheel speed sensor to measure a difference in rotation speed between inner wheels and outer wheels of the vehicle in real time. As long as the turning of the vehicle can be detected, a specific method is not limited, and the technique described above or other techniques known in the related art can be arbitrarily combined.

FIG. 4A is a schematic diagram showing a behavior of the vehicle 100 when the vehicle 100 makes a right turn. As shown in FIG. 4A, in this example, the vehicle 100 passes through the intersection while making a right turn along the hollow arrow. In FIG. 4A, the figure composed of the solid-line circle and the dashed-line cross is used to represent the true azimuth. Regarding the figure, the circle represents a reference for azimuth, and the cross lines represent the directions of east, south, west, and north, respectively. Immediately before the vehicle 100 enters the intersection, the traveling direction is northward, and the true azimuth is 0 degrees. When the vehicle 100 enters the intersection at the point in time t1, the vehicle 100 starts to turn right. Various sensors mounted on the vehicle 100 start to detect a change in the traveling direction of the vehicle 100 from the point in time t1. As the vehicle 100 enters the intersection as indicated by the arrow, the traveling direction of the vehicle 100 gradually shifts clockwise from northward to eastward. The true azimuth of the vehicle 100 gradually increases clockwise from 0 degrees, reaching 30 degrees, and then changing to 90 degrees. At the point in time t2 immediately after the vehicle 100 exits the intersection, the traveling direction is eastward, and the true azimuth becomes 90 degrees. From the point in time t2, the traveling direction of the vehicle 100 stops changing. Various sensors mounted on the vehicle 100 end the detection of the traveling direction at the point in time t3 when the state in which the traveling direction does not change has continued for a predetermined period from the point in time t2 when the traveling direction of the vehicle 100 is detected to stop changing.

FIG. 4B shows a time chart indicating the true azimuth of the vehicle 100 with respect to elapsed time. As shown in FIG. 4B, the true azimuth starts to change from the point in time t1. The true azimuth of the vehicle 100 becomes 90 degrees at the point in time t2. From the point in time t2 when the true azimuth stops changing, the state in which the true azimuth does not change continues. At the point in time t1 when the traveling direction of the vehicle 100 starts to change, the true azimuth is 0 degrees, and at the point in time t2 when the traveling direction of the vehicle 100 stops changing, the true azimuth is 90 degrees. The true azimuth remains unchanged at 90 degrees until the point in time t3 when the predetermined period has continued.

In such a case, since the true azimuth at the point in time t1 immediately before the traveling direction of the vehicle 100 starts to change is 0 degrees, while the true azimuth at the point in time t2 when the traveling direction of the vehicle 100 stops changing is 90 degrees, there is a change in the true azimuth. Moreover, the traveling direction changed by 90 degrees, from northward to eastward, during the period when the traveling direction of the vehicle 100 starts to change to when the traveling direction of the vehicle 100 stops changing. In such a case, where the vehicle 100 makes a right turn at the intersection, the information processing device 10 determines that the recording trigger condition is satisfied at the point in time t3 when the state in which the true azimuth does not change has continued for the predetermined period (S210: YES). Note that the point in time when the recording trigger condition is satisfied is the point in time t2 when the traveling direction of the vehicle 100 stops changing. As a result, the information processing device 10 records the intersection as the position of the vehicle 100 (the process of S220).

### Case Where Vehicle 100 Changes Lane

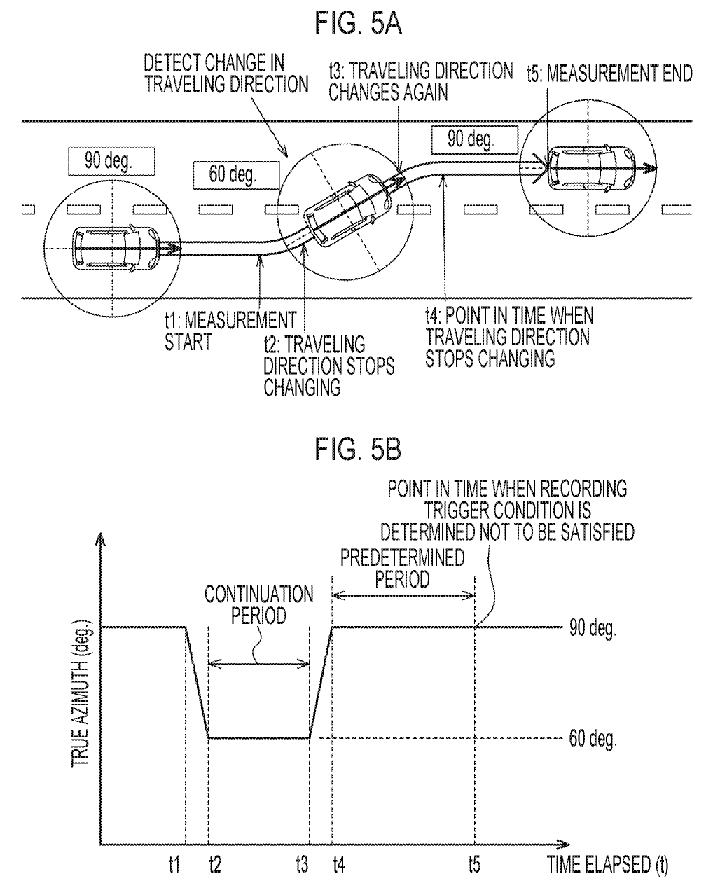

Hereinafter, specific examples of cases where the vehicle 100 changes the lane will be described with reference to FIGS. 5A and 5B.

FIG. 5A is a schematic diagram showing a behavior of the vehicle 100 when the vehicle 100 makes a lane change. As shown in FIG. 5A, in this example, the vehicle 100 makes a lane change along the hollow arrow. The vehicle 100 travels straight in the current lane until the point in time t1, with the traveling direction being eastward, and the true azimuth being 90 degrees. The state represents that the vehicle 100 is stably traveling in the current lane. At the point in time t2, the vehicle 100 starts the lane change, the traveling direction changes from eastward to northward, and the true azimuth changes from 90 degrees to 60 degrees. At the point in time t2, the vehicle 100 leaves the current lane and starts to move into the adjacent lane. From the point in time t2, the true azimuth becomes 60 degrees, and this state of the true azimuth being 60 degrees is maintained until point in time t3. At the point in time t4, the vehicle 100 again returns the traveling direction to the straight direction, and the traveling direction returns to eastward. At the point in time t4, the true azimuth returns to 90 degrees. The vehicle 100 transitions to a straight traveling state in a new lane from the point in time t4.

FIG. 5B is a time chart showing the behavior of the vehicle 100 with respect to elapsed time. FIG. 5B shows a change in the true azimuth of the vehicle 100 associated with the lane change and a continuation period during which the true azimuth does not change. Until the point in time t1, the vehicle 100 has maintained the traveling direction with the true azimuth of 90 degrees. The state indicates that the vehicle 100 is traveling straight in the current lane. Thereafter, from the point in time t1 to the point in time t2, the true azimuth of the vehicle 100 gradually changed from 90 degrees to 60 degrees. The change in the true azimuth indicates that the vehicle 100 has started the lane change. At the point in time t2, the true azimuth of the vehicle 100 becomes 60 degrees, and the state continues until the point in time t3. The period from the point in time t2 to the point in time t3 indicates that the vehicle 100 is entering the adjacent lane from the current lane. The true azimuth of the vehicle 100 changed again at the point in time t3 and returned to 90 degrees at the point in time t4. The behavior indicates that the vehicle 100 has entered the adjacent lane and the traveling direction has shifted to eastward. Although the state in which the traveling direction does not change continues from the point in time t3 to the point in time t4, the continuation period from the point in time t3 to the point in time t4 is shorter than the predetermined period. Therefore, the information processing device 10 has not ended the detection of the traveling direction. From the point in time t4, the traveling direction of the vehicle 100 stops changing. Various sensors mounted on the vehicle 100 end the detection of the traveling direction at the point in time t5 when the state in which the traveling direction does not change has continued for the predetermined period.

In such a case, since the true azimuth immediately before the traveling direction of the vehicle 100 starts to change is 90 degrees and the true azimuth at the point in time when the traveling direction of the vehicle 100 stops changing is 90 degrees, there is no change in the true azimuth. In addition, since the traveling direction at the point in time t1 when the traveling direction of the vehicle 100 starts to change is eastward and the traveling direction at the point in time t4 when the traveling direction of the vehicle 100 stops changing is eastward, the change in the traveling direction is 0 degrees. In such a case, in a case where the vehicle 100 has made the lane change, the information processing device 10 determines that the recording trigger condition is not satisfied (S210: NO). As a result, the information processing device 10 does not record the position of the vehicle 100.

### Example of Determining Travel Route of Vehicle 100 by Information Processing Device 10

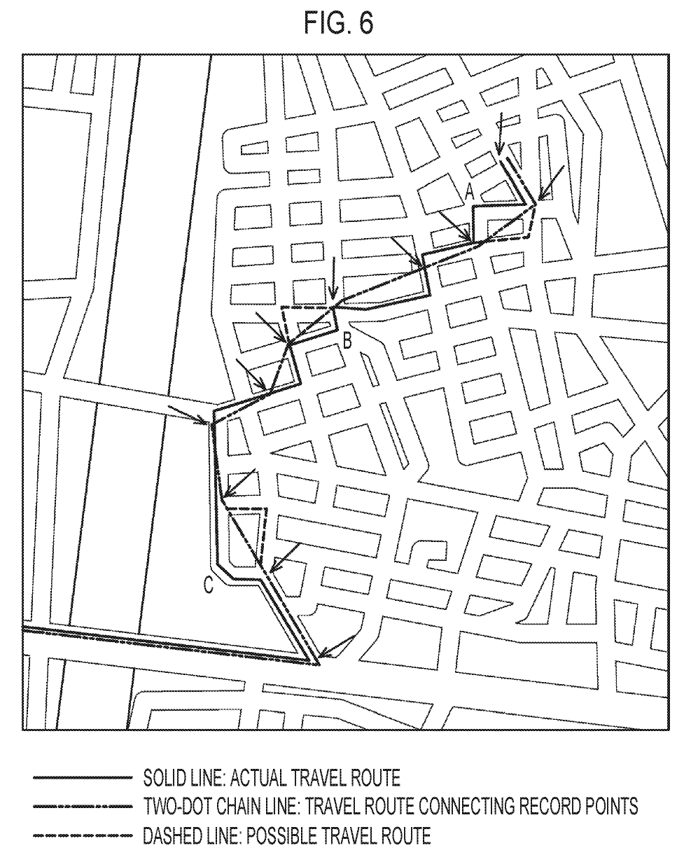

Next, an example of determining the travel route by the information processing device 10 will be described with reference to FIG. 6. FIG. 6 is a diagram for describing a travel route of the vehicle 100. In FIG. 6, a solid line represents a route that the vehicle 100 actually traveled, and a broken line represents other possible routes that the vehicle 100 may have taken. In addition, the arrows shown in FIG. 6 are the positions of the vehicles transmitted from the vehicle 100 to the server 200 at the transmission intervals set according to the speed of the vehicle 100. Since the server 200 collects solely the positions indicated by the arrows, the travel route can be obtained as a two-dot chain line connecting the positions indicated by the arrows. However, from the travel route indicated by the two-dot chain line, it is not possible to determine whether the route that the vehicle 100 actually traveled is the route indicated by the solid line or the route indicated by the broken line.

The information processing device 10 according to the present embodiment determines that the recording trigger condition is satisfied based on the change in the traveling direction of the vehicle 100 at the positions A, B, C. In a case of the position A, the conditions are satisfied that the traveling direction of the vehicle 100 has changed by 45 degrees or more, and that a change exists between the true azimuth immediately before the traveling direction of the vehicle 100 starts to change and the true azimuth at a point in time when the traveling direction of the vehicle 100 stops changing. Therefore, the information processing device 10 can determine that the recording trigger condition is satisfied in a case where the vehicle 100 has traveled on the position A. In this way, the information processing device 10 stores the position information of the vehicle 100 at the position A in the storage device 40. The information processing device 10 stores the position information of the vehicle 100 at the position B and the position C in the storage device 40 in the same manner as the position A. As described above, the information processing device 10 can record a position where a significant course change, such as a right or left turn, a U-turn, or a course selection at a branch point, is made.

### Operation of Present Embodiment

The information processing device 10 includes a position information acquisition device 20 that acquires information indicating a position of a vehicle 100, an information transmission device 30 that periodically transmits the information indicating the position of the vehicle 100 acquired by the position information acquisition device 20 to a server 200, and a storage device 40. The information processing device 10 sets a transmission interval for transmitting the information indicating the position of the vehicle 100 to the server 200 such that the transmission interval becomes shorter as a vehicle speed of the vehicle 100 decreases. The information processing device 10 is configured to determine whether a recording trigger condition is satisfied based on a change in a traveling direction of the vehicle 100, and to store information indicating a position of the vehicle 100 at a time when the recording trigger condition is satisfied in a storage device 40 when the recording trigger condition is determined to be satisfied.

The information processing device 10 sets a transmission interval to be shorter as the vehicle speed decreases, thereby transmitting information indicating the position of the vehicle 100 to the server 200 at a higher frequency during low-speed movement. The information processing device 10 records information indicating a position of the vehicle 100 at a time when a recording trigger condition based on a change in a traveling direction of the vehicle 100 is satisfied.

### Effect of Embodiment

(1) For example, in an area such as a business district or a residential district, the facilities or the houses are densely packed, so that there are many intersections, and the intersections are often connected by a plurality of routes. The information processing device 10 is capable of providing detailed travel information by shortening the transmission interval according to the vehicle speed when the vehicle 100 moves at a low speed in such an area, thereby transmitting the position of the vehicle 100 to the server 200 at a high frequency.

In addition, the information processing device 10 stores, in the storage device 40, the information indicating the position of the vehicle 100 at the time when the recording trigger condition based on the change in the traveling direction of the vehicle 100 is satisfied. As described above, the information processing device 10 can record a position where a significant course change, such as a right or left turn, a U-turn, or a course selection at a branch point, is made. Therefore, the information processing device 10 can provide the information on the accurate movement trajectory even in a situation where the vehicle 100 is traveling in an area where a plurality of routes exist between the intersections. As a result, the information processing device 10 can determine a course change, independent of a road or a terrain, so that a right or left turn or a U-turn at an intersection, a branch point, or the like can be accurately recorded.

(2) The information processing device 10 is configured to determine that the recording trigger condition is satisfied when both of the following conditions are satisfied: a change exists between a true azimuth immediately before the traveling direction of the vehicle 100 starts to change and a true azimuth at a point in time when the traveling direction of the vehicle 100 stops changing; and the traveling direction has changed by 45 degrees or more during a period from when the traveling direction of the vehicle 100 starts to change to when the traveling direction of the vehicle 100 stops changing.

In the information processing device 10, the temporary fluctuation of the traveling direction of the vehicle 100 is excluded, and the recording trigger condition is satisfied in a case of a clear change in the traveling direction, such as a right or left turn at the intersection. In this way, the recording trigger condition excludes the minor fluctuation of the traveling direction caused by the lane change or the irregularity of the road.

(3) The information processing device 10 is configured to determine whether the recording trigger condition is satisfied when a state in which the traveling direction does not change has continued for a predetermined period from the point in time when the traveling direction of the vehicle 100 stops changing, and when the recording trigger condition is determined to be satisfied, set the point in time when the traveling direction stops changing as the point in time when the recording trigger condition is satisfied.

In a case of the lane change, the traveling direction is shifted toward the target lane side, and, for a short period, the traveling direction may be maintained in that direction until the vehicle fully moves into the target lane. Then, once the move into the target lane is completed, the traveling direction is returned to the original traveling direction. In the above configuration, the recording trigger condition is determined to be satisfied based on the fact that the state in which the traveling direction does not change has continued for a predetermined period. Therefore, it is possible to avoid recording each of the two changes in the traveling direction that are made in a short period during the lane change.

(4) When the recording trigger condition is determined to be satisfied, the information processing device 10 is configured to transmit, to the server 200, the information indicating the position of the vehicle 100 at the time when the recording trigger condition is satisfied.

In the information processing device 10, the information on the position where the course change has occurred is immediately transmitted to the server 200. As a result, the information processing device 10 can build a foundation for generating an accurate travel route in real time according to the course change of the vehicle 100, and thus can contribute to the advancement of the analysis of the traffic situation.

### Modifications

The present embodiment described above can be modified and carried out as follows. The present embodiment described above and the following modifications can be carried out in combination within a technically consistent range.

In the embodiment, when the recording trigger condition is determined to be satisfied, the information processing device 10 is configured to transmit, to the server 200, the information indicating the position of the vehicle 100 at the time when the recording trigger condition is satisfied. In contrast, the timing for transmitting the information indicating the position of the vehicle 100 at the time when the recording trigger condition is determined to be satisfied may be changed. For example, at a transmission timing according to the transmission interval determined by the vehicle speed of the vehicle 100, the information processing device 10 is configured to transmit the information indicating the position of the vehicle 100 at the time when the recording trigger condition is satisfied, the information being stored in the storage device 40, to the server 200 together with information indicating a position of the vehicle 100 at the point in time.

In the information processing device 10 in this case, when the recording trigger condition is satisfied, the information indicating the position of the vehicle 100 is not immediately transmitted to the server 200, but is transmitted in a batch at a timing based on the transmission interval. In an area where the traveling direction frequently changes, there is a high likelihood that the recording trigger condition is repeatedly satisfied. By adopting such a configuration, the information processing device 10 can suppress the number of times of transmission by temporarily storing the recording content in the storage device 40 and transmitting the recording content in a batch according to the transmission interval corresponding to the vehicle speed. As a result, it is possible to suppress an increase in the load on the information processing device 10.

In the embodiment, when the speed of the vehicle 100 is determined to be lower than the predetermined value (S200: YES), the determination is made as to whether the recording trigger condition is satisfied. However, regardless of the speed of the vehicle 100, it is permissible to continuously determine whether the recording trigger condition is satisfied while the vehicle 100 is in operation.

In the present embodiment, the change in the traveling direction is determined by using the true azimuth. However, as long as the change in the traveling direction can be determined, a coordinate system of a left-hand system or a right-hand system, or relative direction data can be used. For example, the change in the traveling direction is determined by using the relative azimuth or the traveling direction data acquired by the sensor of the vehicle without using the true azimuth.

What is claimed is:

1. An information processing device for a vehicle, the information processing device comprising:
a position information acquisition device configured to acquire information indicating a position of the vehicle;
an information transmission device configured to periodically transmit, to a server, the information indicating the position of the vehicle acquired by the position information acquisition device; and
a storage device,
wherein the information processing device is configured to execute:
setting a transmission interval for transmitting the information indicating the position of the vehicle to the server such that the transmission interval becomes shorter as a vehicle speed of the vehicle decreases; and
determining whether a recording trigger condition is satisfied based on a change in a traveling direction of the vehicle, and when the recording trigger condition is determined to be satisfied, storing, in the storage device, information indicating a position of the vehicle at a time when the recording trigger condition is satisfied.

2. The information processing device according to claim 1, wherein the recording trigger condition is determined to be satisfied when both of following conditions are satisfied:
a change exists between a true azimuth immediately before the traveling direction of the vehicle starts to change and a true azimuth at a point in time when the traveling direction of the vehicle stops changing; and
the traveling direction of the vehicle has changed by 45 degrees or more during a period from when the traveling direction of the vehicle starts to change to when the traveling direction of the vehicle stops changing.

3. The information processing device according to claim 2, wherein:
determination is made as to whether the recording trigger condition is satisfied when a state in which the traveling direction of the vehicle does not change has continued for a predetermined period from the point in time when the traveling direction of the vehicle stops changing; and
when the recording trigger condition is determined to be satisfied, the point in time when the traveling direction of the vehicle stops changing is set as a point in time when the recording trigger condition is satisfied.

4. The information processing device according to claim 1, wherein, when the recording trigger condition is determined to be satisfied, the information indicating the position of the vehicle at the time when the recording trigger condition is satisfied is transmitted to the server.

5. The information processing device according to claim 1, wherein, at a transmission timing according to the transmission interval determined by the vehicle speed of the vehicle, the information indicating the position of the vehicle at the time when the recording trigger condition is satisfied, the information being stored in the storage device, is transmitted to the server together with information indicating a position of the vehicle at the transmission timing.
